(19) United States
(12) Patent Application Publication
(10) Pub. No.: US 2009/0178194 A1
(43) Pub. Date: Jul. 16, 2009

(54) Manual Lifting Pelvic Harness

(76) Inventor: Delia Story, Tempe, AZ (US)

Correspondence Address: THE LUTHER LAW FIRM, PLC, 10575 N 114TH STREET, SUITE 103, SCOTTSDALE, AZ, 85259, US

(21) Appl. No.: 12/333,198

(22) Filed: Dec. 11, 2008

Related U.S. Application Data
(60) Provisional application No. 61/012,806, filed on Dec. 11, 2007.

(51) Int. Cl. A61G 7/10

(52) U.S. Cl. 5/81.1 R

(57) ABSTRACT

A manual lifting pelvic harness for lifting or otherwise assisting debilitated patients has a adjustable belt, adjustable straps for encircling the thighs adjacent the buttocks, and fasteners such as tongues and buckles for securing the belt about the patient and securing the straps to the belt. Straps encircle the legs independently or cross over at the patient's crotch. The belt is wide, padded and slightly stiff. Alternatively, the straps have links at their ends and the links fit over the tongue of the belt before the tongue is inserted into the buckle to fasten the belt.

This application claims the benefit of U.S. Provisional Patent Application No. 61/012,806, filed Dec. 11, 2007.

### BACKGROUND OF THE INVENTION

1. Field of the Invention

The present invention generally relates to devices for lifting people, and more particularly relates to portable hand-operated slings and methods of using the same.

### GENERAL BACKGROUND

2. State of the Art

An increasing population of debilitated people cannot move from bed to chair and back without assistance. There is a rapidly increasing population of the elderly and debilitated who need help in moving. Caregivers may try to pick up patients by the arms, sometimes causing bruises. Another convenient way of helping a person out of a chair is pulling upward on the waistband of pants, but pants are not manufactured for weight bearing and such pressure on the perineum can be painful.

Individuals requiring assistance range from those with little strength in their legs but active arms, to those who are permanently rigid or flaccid and difficult to move because of those factors. In addition, patients with Alzheimer's disease may be able to ambulate away from their chairs or beds but become confused and require assistance and lifting to return to beds and chairs.

Other patients needing assistance are obese or become obese from lack of exercise. A recent study reports the proportion of obese adults in the United States as one third. Often such individuals require the assistance of two caregivers. Two caregivers often are not available in private homes or in small nursing home settings, particularly at night. If large patients fall out of bed at night with a single caregiver, one caregiver may not be able to return the patient to bed. Then the patient must be made “comfortable” until the morning shift arrives with more assistance.

Lifting patients is also hard on the caregivers. Few caregivers are strong young men. Most are women, and many are not particularly tall or strong. Caregivers cite a variety of injuries, such as to the back, shoulder, wrist and elbow, from striving to move patients under current circumstances. While an obvious solution for these problems would be to install ceiling pulleys to lift patients. most people in charge of the long-term care environment eschew those for a more home-like atmosphere. Further, pulleys only help where they are located.

Various contraptions have been tried over the years, including various slings and belts. Simple belts have a tendency to slip upward to the patient's armpits and to make carrying the patient impossible for a short caregiver. Slings under the patient's buttocks also can slip and let the patient slide down; such action pulls forward the caregiver and stretches the back.

What is needed is a lifting belt applicable to a patient in the seated position, without need to significantly reposition the patient during placing the belt. Also needed is a method to move the patient up and forward toward the caregiver (for ease of maneuvering) by lifting the patient by applying pressure through the hip and pelvic area on an angle designed to tilt the patient toward the caregiver. Also needed is a harness that is applied in such a way as to enable the belt to remain securely in place during the process of lifting and moving the patient. Clearly, the new device needs to help avoid injury to both the patient and caregiver.

### INVENTION SUMMARY

An exemplary embodiment of the manual lifting pelvic harness in accordance with the present invention has a torso-encircling belt having ends releasably joinable one to another; and left and right leg-encircling straps each joined proximally to the belt and each connectable to the belt. The straps cradle the patient by passing along the gluteal fold between the patient's thighs and buttocks, preventing the belt from sliding up the patient's torso when the caregiver lifts the belt for the purpose of positioning, guiding or moving the patient.

An exemplary embodiment in accordance with the present invention has a hand-graspable lifting handle joined to the belt to make it easier for the caregiver to lift the belt and move the patient. The harness may have a plurality of hand-graspable lifting handles joined to the belt, at least one of the lifting handles being located intermediate the lengthwise midpoint of the belt and each end thereof, so that, when the belt is secured about a patient's waist, at least one handle is located above and slightly to the rear of each of the patient's hips, so that, when the caregiver stands in front of the patient and lifts the handles, the patient is gently urged or tilted forward toward the caregiver.

An exemplary embodiment in accordance with the present invention has a buckle attached to a first end of the belt and a tongue attached to an end of the belt opposite the first end, the buckle and the tongue being adapted for mutual selectively releasable engagement. Thus, it is easy to buckle and unbuckle the belt—as if it were a seatbelt. Seatbelt-style tongue-and buckle apparatus are an exemplary fastener for this embodiment. However, other fasteners are also practical and may be preferable. For example, the spring-biased fork-type or bayonet-type of fasteners found on fanny packs and backpacks are also suitable, provided they are heavy-duty and not easily accidentally released. These fasteners have the advantage of being nonmetallic and washable.

An exemplary embodiment in accordance with the present invention has a tongue and a length adjustment disposed on each of the left and right leg-encircling straps, the length adjustment being releasably securable against tension between the tongue and the strap. A left buckle segment is attached to the belt proximate the left leg encircling strap and distally equipped with a buckle. A right buckle segment is attached to the belt proximate the right leg encircling strap and distally equipped with a buckle. The buckles and the tongues are adapted for mutual selectively releasable engagement. Thus, the caregiver can easily buckle and unbuckle the straps.

In an exemplary embodiment, the left leg-encircling strap is engageable with the buckle located on the right buckle segment and the right leg-encircling strap is engageable with the buckle located on the left buckle segment. This crossed arrangement cradles the patient differently and, often, more comfortably than the uncrossed arrangement.

In exemplary embodiment in accordance with the present invention, each of the left and right leg-encircling straps is equipped with a link adapted for engagement with the belt.

In an exemplary embodiment in accordance with the present invention, the belt has a first end equipped with a tongue and a second end equipped with a buckle, the tongue and the buckle being adapted for mutual selectively releasable engagement so that the belt can easily be fastened about the patient.

In an exemplary embodiment in accordance with the present invention, the belt has a first end equipped with a tongue and a second end equipped with a buckle, the tongue and the buckle being adapted for mutual selectively releasable engagement. The link of each of the left and right leg-encircling straps is adapted to encircle the tongue of the belt and the tongue of the belt is adapted for the mutual selectively releasable engagement with the buckle while the links are encirclingly disposed on the tongue.

An exemplary embodiment in accordance with the present invention has a padded patch movably disposed on each of the leg-encircling straps to pad the straps so that they more comfortably engage the patient's body.

In an exemplary embodiment in accordance with the present invention, the belt includes a pad and a stiffener. The pad and stiffener help cushion and distribute the load the belt applies to the patient during lifting. The stiffener facilitates inserting the belt behind or under a supine or seated patient.

A method of harnessing a seated or supine patient in accordance with the present invention has the steps of partially encircling a patient's torso with a belt; securing the belt about the patient's waist slightly above the patient's hips; securing a first end of a left strap to a point on the belt at the patient's left side, passing a second end of the left strap beneath the patient's left thigh and forward between the patient's thighs, and joining the second end of the left strap to the belt proximate the patient's left side and abdomen; securing a first end of a right strap to a point on the belt at the patient's left side, passing a second end of the right strap beneath the patient's right thigh and forward between the patient's thighs, and joining the second end of the right strap to the belt proximate the patient's right side and abdomen. This method comfortably and safely lifts the patient.

An alternative, and often preferred, method of harnessing a seated or supine patient, having the steps of partially encircling a patient's torso with a belt; securing the belt about the patient's waist slightly above the patient's hips; securing a first end of a left strap to a point on the belt at the patient's left side, passing a second end of the left strap beneath the patient's left thigh and forward between the patient's thighs, and joining the second end of the left strap to the belt proximate the patient's right side and abdomen; securing a first end of a right strap to a point on the belt at the patient's left side, passing a second end of the right strap beneath the patient's right thigh and forward between the patient's thighs, and joining the second end of the right strap to the belt proximate the patient's left side and abdomen. This alternative method crosses the straps. The inventor found that crossing the straps sometimes improves patient comfort.

In these methods, the caregiver may add the step of pulling snug the left leg-encircling strap and the right leg-encircling strap.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 is a perspective view of an exemplary embodiment of a manual lifting pelvic harness in accordance with the present invention as viewed from the front;

FIG. 2 is a partial perspective view thereof, showing the harness fastened about a human torso; and

FIG. 3 is a perspective view of another exemplary embodiment of a manual lifting pelvic harness in accordance with the present invention as viewed from the front.

### DETAILED DESCRIPTION OF THE PREFERRED EMBODIMENTS

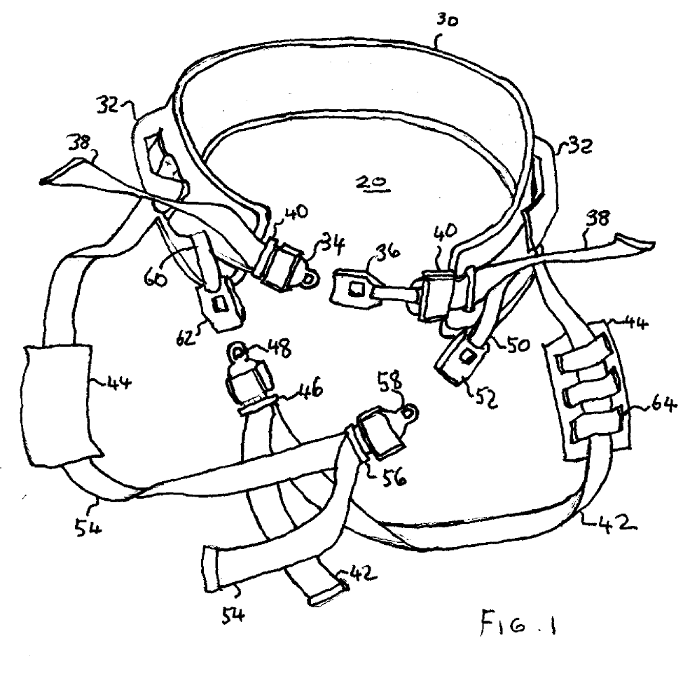

The invention will now be described with reference to FIG. 1, which illustrates in perspective view a preferred embodiment of the manual lifting pelvic harness in accordance with the present invention, shown generally at 20, having a belt 30 with lifting handles 32, a belt tongue 34, a belt buckle 36 and belt extensions 38 with belt length adjustments 40; a left strap 42 with a pad 44, a left length adjustment 46 and a left tongue 48; a left buckle segment 50 with a left buckle 52; a right strap 54 with a pad 44, a right length adjustment 56 and a right tongue 58; and a right buckle segment 60 with a right buckle 62.

With continued reference to FIG. 1, the belt 30 has sufficient length—about 0.8 to 1.2 m (33-49 in.)—to substantially encircle a patient who may be somewhat overweight, at a level above the pelvis and below the waist or, colloquially speaking, just above the hips. The belt 30 may comfortably overlap itself on a slender patient or it may incompletely encircle an obese patient. The belt 30 is formed of a flexible, durable, non-abrasive, stain-resistant material such as polyester or nylon. The belt 30 has a width of approximately 5 cm (2 in.) from edge to edge and is thickened and stiffened by means of a plastic, textile or foam insert sewn within as is commonly observed in knapsack shoulder straps and the like, so that it may be secured snugly about a patient's waist with minimal risk of discomfort and bruising. The belt 30 itself is open-ended, so that it may be drawn endwise around a patient's torso and positioned for closure.

With continued reference to FIG. 1, the lifting handles 32 are formed of a durable material such as polyester or nylon and are sewn or riveted permanently onto the belt 30 in a manner enabling a person to firmly grasp one handle with each hand. Alternatively, the lifting handles 32 are formed of hard plastic, metal, wooden dowels, or the like anchored endwise to the belt 30. The lifting handles 32 are located on the belt 30 so that, when the belt 30 is worn by a patient, the lifting handles 32 are located lateral of the patient's spine and posterior to the patient's sides. Alternatively, the lifting handles 32, which may number more than two, are located at a variety of points along the length of the belt 30. The belt extensions 38 project endwise from the belt 30 and are preferably formed from a continuous strip of a flexible, durable, stain-resistant material and sewn permanently onto the belt 30. One belt extension 38 has a belt length adjustment 40 with a belt tongue 34 attached. The belt tongue 34 is formed of metal or some other material having sufficient tensile strength and durability to reliably close a belt 30 which is to be used to lift a person. The other belt extension 38 has a belt length adjustment 40 with a push-button-release-type belt buckle 36 attached, the belt buckle 36 and the belt tongue 34 being adapted for mutual selectively releasable engagement.

With continued reference to FIG. 1, the left strap 42 is formed of a flexible, durable, non-abrasive, stain-resistant material such as polyester or nylon and is sewn or riveted to the belt 30 somewhat below a lifting handle 32. The left strap 42 passes through the left length adjustment 46 with the left tongue 48 (also formed of metal or other strong, durable material) attached. The left strap 42 has a length of about 0.4 to 0.6 m (about 17-26 in.) and, in any event, a length sufficient to encircle the upper thigh of a patient who may be somewhat overweight. A pad 44 is held onto the left strap 42 by means of elasticized fabric loops 64 and can slide along the left strap 42 and, if desired, off past the left tongue 48. The pad 44 provides increased comfort and reduces the risk of injury in the gluteal fold area when the patient is being lifted. The left buckle segment 50 has a length of about 0.1 m (about 4 in.) and is formed of a flexible, durable, stain-resistant material such as polyester or nylon. The left buckle segment 50 is sewn or riveted to the belt 30 somewhat forward of a lifting handle 32, and terminates at the push-button-release-type left buckle 52 which is adapted to releasably retain the left tongue 48. As can be seen in the figure, the right strap 54 with pad 44, right length adjustment 56 and right tongue 58; and the right buckle segment 60 with right buckle 62, are formed, arranged and attached in the manner set forth for the left, but on the opposite side of the belt 30.

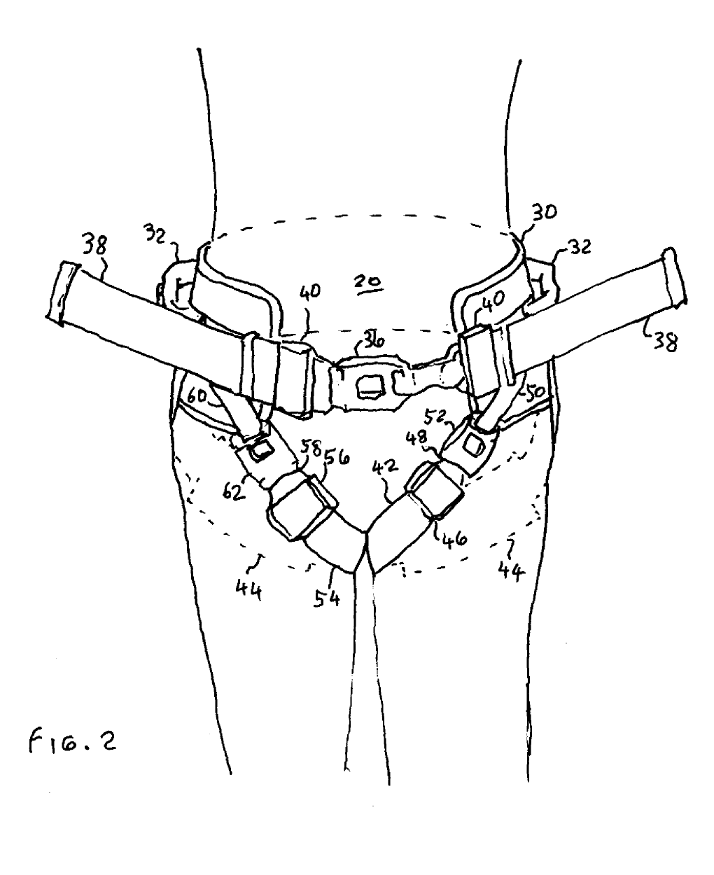

FIG. 2, a partial perspective view of the manual lifting pelvic harness in accordance with the present invention fastened about a human torso, shows the belt 30 with lifting handles 32, the belt tongue 34 inserted in the belt buckle 36, the belt extensions 38 extending across the front of the patient's abdomen, the belt length adjustments 40 pulled snug; the left strap 42 with pad 44 (drawn in dotted line) positioned on the patient's gluteal fold, i.e., roughly where the buttock meets the hamstring muscle, the left length adjustment 46 pulled snug, the left tongue 48 inserted in the left buckle 52 attached to the left buckle segment 50; the right strap 54 with pad 44 (also drawn in dotted line), the right length adjustment 56 pulled snug, the right tongue 58 inserted in the right buckle 62 attached to the right buckle segment 60.

With reference to FIG. 1 and FIG. 2, the manual lifting pelvic harness is used as follows: First, the belt 30 is wrapped around the patient so that it sits below the patient's waist and above the superior portions of the patient's pelvis. The belt 30 is centered over the patient's lumbar spine. The belt extensions 38 are brought together in front of the patient. The belt tongue 34 is inserted into the belt buckle 36. The belt length adjustments 40 are adjusted by pulling the belt extensions 38 distal of the belt length adjustments 40 until the belt 30 fits snugly around the patient and thus is less likely to slip when the patient is lifted.

Next, with continued reference to FIG. 1 and FIG. 2, the left strap 42 is passed under the patient's left thigh and the right strap 54 is passed under the patient's right thigh—in both cases, from the outside, behind the patient's hamstring muscle, and forward between the patient's thighs. If necessary, the caregiver lifts the patient's knee and passes the left strap 42 under the patient's left thigh. The procedure is repeated to pass the right strap 54 around the patient's right leg. When the left tongue 48 and the right tongue 58 are positioned between the patient's thighs, the caregiver pulls them up toward the left buckle 52 and right buckle 62. The left strap 42 is inserted into the left buckle 52 and the left length adjustment 46 is adjusted by pulling the left strap 42 relative to the left length adjustment 46. The right tongue 58 is inserted in the right buckle 62 and likewise adjusted.

In a variation on this procedure, not specifically illustrated in FIG. 2 but suggested in FIG. 1, the caregiver inserts the left strap 42 into the right buckle 62 and inserts the right strap 54 into the left buckle 52, with the result that the left strap 42 and the right strap 54 cross over one another at the patient's crotch. In some cases, this crossed-over arrangement cradles the patient more comfortably and reduces the tendency of the left strap 42 and the right strap 54 to bite into the patient's flesh as the caregiver lifts the patient. Thus, advantages of this preferred embodiment of the present invention include that the left buckle 52 and the right buckle 62 are spaced apart far enough that a meaningful difference is made in whether the left strap 42 and the right strap 54 are crossed or uncrossed (loads are applied differently across the buttocks and crotch area of the patient), and that the caregiver is free to decide in each situation whether to use the left strap 42 and the right strap 54 crossed or uncrossed. It should also be noted that a heavier patient usually has a larger waist, with the result that, when the belt 30 is secured on the patient, the left buckle 52 and the right buckle 62 are spaced apart a greater distance. Thus, in the heavier patient, where loads are greater, the crossed arrangement of the left strap 42 and the right strap 54 advantageously results in a more pronounced redistribution of the load across the patient's buttocks and crotch area. Another advantage is that the separate left buckle 52 and right buckle 62 are easily identified and manipulated.

With continued reference to FIG. 1 and FIG. 2, to lift the harnessed patient, the caregiver stands with knees bent, facing the patient, and grasps each lifting handle 32 at a position which is slightly posterior to lateral, so that the weight of the patient is greater toward the caregiver. The caregiver then has a capable patient lean forward with the patient's hands on the caregiver's shoulders. The caregiver then stands erect with straightened knees while lifting the patient, who can then be moved to another location.

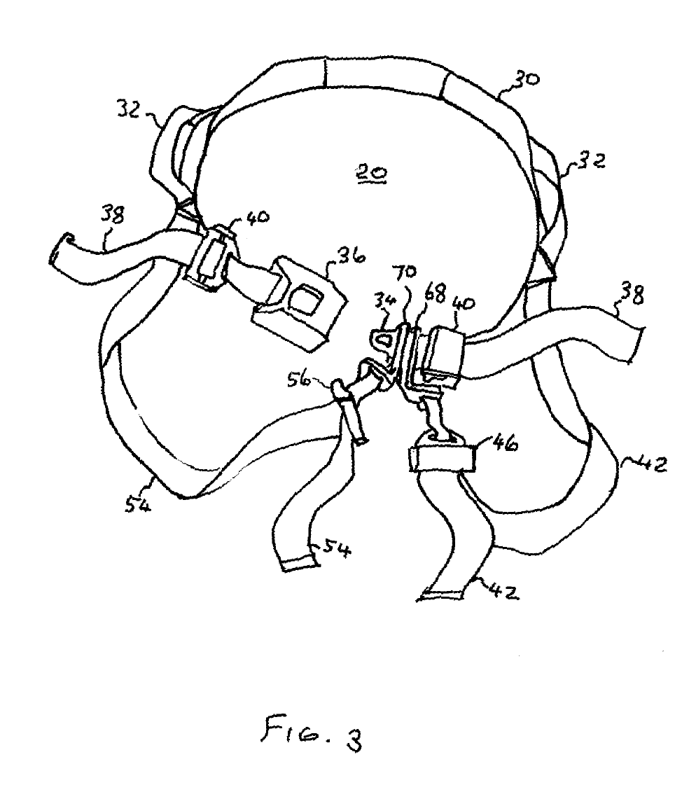

FIG. 3 is a perspective view an alternative embodiment of the manual lifting pelvic harness in accordance with the present invention, shown generally at 20, having a belt 30 with lifting handles 32, a belt tongue 34, a belt buckle 36 and belt extensions 38 with belt length adjustments 40; a left strap 42 with left length adjustment 46 and left link 68; and a right strap 54 with right length adjustment 56 and right link 70. The manual lifting pelvic harness in this alternative embodiment is constructed in the same manner and incorporates the same materials as does the embodiment of FIG. 1, the left link 68 and the right link 70 being formed of metal or other durable material having high tensile strength for carrying lifting loads. Like the left tongue 48 and the right tongue 58 of the embodiment of FIG. 1, the left link 68 and the right link 70 of this alternative embodiment are attached to the left length adjustment 46 and the right length adjustment 56 and left strap 42 and right strap 54, respectively, in a manner commonly observed in seatbelts, knapsack straps and the like, such that the length can be reduced by pulling the left strap 42 through the left length adjustment 46, for example.

With continued reference to FIG. 3, it is seen that the manual lifting pelvic harness in accordance with this alternative embodiment is usable in the same manner as initially described for the embodiment of FIG. I, one difference, however, being that to secure the left strap 42 and the right strap 54 to the belt 30, the caregiver passes the belt tongue 34 through both the left link 68 and the right link 70 before inserting the belt tongue 34 into the belt buckle 36. After this step, the left strap 42 and the right strap 54 may be pulled snug as needed. The belt tongue 34 in this embodiment may be elongated to provide clearance for the left link 68 and the right link 70 while still being insertable in the belt buckle 36. An advantage of this alternative embodiment is the simplicity and cost savings achieved by the omission of the left buckle 52 and the right buckle 62.

In the inventor's experience, moving a disabled patient is a difficult and delicate activity which frequently results in injury to a caregiver. As can be seen from the drawing figures and from the description, each embodiment of the manual lifting pelvic harness in accordance with the present invention makes this activity easier and safer by addressing the unmet need for a safe, practical, portable, affordable, comfortable way of lifting and moving a patient.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R § 1.72(b) requiring an Abstract that will allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Description of Preferred Embodiments of the Invention, with each claim standing on its own as a separate preferred embodiment.

While the specification describes particular embodiments of the present invention, those of ordinary skill can devise variations of the present invention without departing from the inventive concept.

I claim:

1. A manual lifting pelvic harness for moving a patient, comprising:
a torso-encircling belt having ends releasably joinable one to another; and
left and right leg-encircling straps each joined proximally to said belt and each connectable to said belt.

2. Apparatus as set forth in claim 1, comprising a hand-graspable lifting handle joined to said belt.

3. Apparatus as set forth in claim 1, comprising a plurality of hand-graspable lifting handles joined to said belt, at least one of said lifting handles being located intermediate the lengthwise midpoint of said belt and each end thereof.

4. Apparatus as set forth in claim 1, comprising a buckle attached to a first end of said belt and a tongue attached to an end of said belt opposite said first end, said buckle and said tongue being adapted for mutual selectively releasable engagement.

5. Apparatus as set forth in claim 1, comprising:
a tongue and a length adjustment disposed on each of said left and right leg-encircling straps, said length adjustment being releasably securable against tension between said tongue and said strap;
a left buckle segment attached to said belt proximate said left leg encircling strap and distally equipped with a buckle; and
a right buckle segment attached to said belt proximate said right leg encircling strap and distally equipped with a buckle,
said buckles and said tongues being adapted for mutual selectively releasable engagement.

6. Apparatus as set forth in claim 1, wherein said left leg-encircling strap is engageable with said buckle located on said right buckle segment and said right leg-encircling strap is engageable with said buckle located on said left buckle segment.

7. Apparatus as set forth in claim 1, wherein each of said left and right leg-encircling straps is equipped with a link adapted for engagement with said belt.

8. Apparatus as set forth in claim 1, wherein said belt has a first end equipped with a tongue and a second end equipped with a buckle, said tongue and said buckle being adapted for mutual selectively releasable engagement.

9. Apparatus as set forth in claim 7, wherein said belt has a first end equipped with a tongue and a second end equipped with a buckle, said tongue and said buckle being adapted for mutual selectively releasable engagement, and wherein said link of each of said left and right leg-encircling straps is adapted to encircle said tongue of said belt and said tongue of said belt is adapted for said mutual selectively releasable engagement with said buckle while said links are encirclingly disposed on said tongue.

10. Apparatus as set forth in claim 1, comprising a padded patch movably disposed on each of said leg-encircling straps.

11. Apparatus as set forth in claim 1, wherein said belt includes a pad and a stiffener.

12. A method of harnessing a seated or supine patient, having the steps of:
partially encircling a patient's torso with a belt;
securing said belt about the patient's waist slightly above the patient's hips;
securing a first end of a left strap to a point on said belt at the patient's left side, passing a second end of said left strap beneath the patient's left thigh and forward between the patient's thighs, and joining said second end of said left strap to said belt proximate the patient's left side and abdomen;
securing a first end of a right strap to a point on said belt at the patient's left side, passing a second end of said right strap beneath the patient's right thigh and forward between the patient's thighs, and joining said second end of said right strap to said belt proximate the patient's right side and abdomen.

13. A method of harnessing a seated or supine patient, having the steps of:
partially encircling a patient's torso with a belt;
securing said belt about the patient's waist slightly above the patient's hips;
securing a first end of a left strap to a point on said belt at the patient's left side, passing a second end of said left strap beneath the patient's left thigh and forward between the patient's thighs, and joining said second end of said left strap to said belt proximate the patient's right side and abdomen;
securing a first end of a right strap to a point on said belt at the patient's left side, passing a second end of said right strap beneath the patient's right thigh and forward between the patient's thighs, and joining said second end of said right strap to said belt proximate the patient's left side and abdomen.

14. A method as set forth in claim 12, having the step of pulling snug said left leg-encircling strap and said right leg-encircling strap.

15. A method as set forth in claim 13, having the step of pulling snug said left leg-encircling strap and said right leg-encircling strap.
